(19) United States
(12) Patent Application Publication
(10) Pub. No.: US 2023/0410828 A1
(43) Pub. Date: Dec. 21, 2023

(54) SYSTEMS AND METHODS FOR ECHO MITIGATION

(71) Applicant: Apple Inc., Cupertino, CA (US)

(72) Inventors: Ramin Pishehvar, La Crescenta, CA (US); Mehrez Souden, Los Angeles, CA (US); Sean A. Ramprashad, Los Altos, CA (US); Jason Wung, Santa Clara, CA (US); Ante Jukic, Culver City, CA (US); Joshua D. Atkins, Los Angeles, CA (US)

(21) Appl. No.: 17/845,655

(22) Filed: Jun. 21, 2022

(51) Int. Cl. G10L 21/0232; G06V 40/16; G10L 25/84; G10L 21/034; G10L 21/0364; G10L 15/25; G10L 15/06; G10L 15/22

(52) U.S. Cl. CPC G10L 21/0232; G06V 40/161; G10L 25/84; G10L 21/034; G10L 21/0364; G10L 15/25; G10L 15/063; G10L 15/22

(57) ABSTRACT

Disclosed is a reference-less echo mitigation or cancellation technique. The technique enables suppression of echoes from an interference signal when a reference version of the interference signal conventionally used for echo mitigation may not be available. A first stage of the technique may use a machine learning model to model a target audio area surrounding a device so that a target audio signal estimated as originating from within the target audio area may be accepted. In contrast, audio signals such as playback of media content on a TV or other interfering signals estimated as originating from outside the target audio area may be suppressed. A second stage of the technique may be a level-based suppressor that further attenuates the residual echo from the output of the first stage based on an audio level threshold. Side information may be provided to adjust the target audio area or the audio level threshold.

### FIELD

This disclosure relates to the field of audio communication including machine-learning techniques for use in consumer electronic devices to suppress interference signals when using the consumer communication devices to receive speech in the presence of the interference signals. Other aspects are also described.

### BACKGROUND

Consumer electronic devices such as smartphones, tablets, desktop computers, laptop computers, laptop computers, intelligent personal assistant devices, etc., receive speech from speakers engaged in conversation during a phone call or video conference call. The devices may also be controlled by users issuing speech commands to the devices. For example, users may issue voice commands to the devices to make phone calls, send messages, play media content, obtain query responses, get news, setup reminders, etc. Speech from a target speaker may be interfered by voice from competing speakers, background noise, artifacts due to the acoustic environment, etc. In one application, users in a phone or video call may share media content with one another to create a shared media playback experience among the participants. For example, a near-end user may playback media content locally on a separate device such as a display monitor while using a smartphone to stream a media file to other participants of a video conference call to enable remote playback of the same media content. The remote participants may hear their own version of the media playback and also echoes of the local playback picked up by the smartphone of the near-end user. To cancel echoes of media playback in a media sharing experience during telephony or video conference calls, the smartphone may need to isolate the target speech of the near-end user while suppressing interference from the local media playback in addition to removing interference from other interference sources.

### SUMMARY

Users may use smartphones, smart assistant devices, smartwatches, computers or other electronic devices in an audio or video conference call. Speech signals called target speech from a user may be mixed with interference sound from the noisy environment local to the user. In a shared playback mode of the call, the device may stream media content to another device such as a television for local playback while transmitting the media content to far-end participants of the call. The far-end users may use their devices to stream the received media content to televisions on their side for playback to share in the media playback experience. The device local to the user may capture audio from the local playback in addition to the target speech of the user. If the local playback is not mitigated, the far-end users may hear audio from the media playback on their side and also echoes of the media playback from the local user's side. However, it may be difficult to mitigate the echoes of the local media playback at the remote locations due to the lack of a reference signal for echo cancellation. The media content may not be used as such a reference signal due to issues such as transmission delays, causality between the local playback and the remote playback, non-linearity in the communication channel, synchronization, etc.

Systems and methods are disclosed for a reference-less echo mitigation or cancellation technique. The technique enables suppression of echoes from an interference signal when a reference version of the interference audio signal conventionally used for echo mitigation may not be available such as in the shared media playback mode of a conference call. The technique may be applied more broadly to suppress interference signals in an acoustic environment in which the interference signal source may be at a different distance from a device than the distance of target signal source. In one aspect, suppression of interfering signals from a target audio signal without relying on a reference copy of the interfering signals may involve a two-stage solution.

The first stage may model a target audio area surrounding a device so that a target audio signal (e.g., target speech) estimated as originating from within the target audio area may be accepted. In contrast, audio signals such as playback of media content on a TV or other interfering signals estimated as originating from outside the target audio area may be suppressed. The model may allow a user of the device to converse with others in a conference call but the local playback audio from the TV that is further away from the device than the user and that is located outside of the target audio area may be suppressed. The first stage may generate an audio signal that has much less echo of the playback audio than the audio signal captured by the device. In one aspect, the first stage may be modeled by a machine learning model such as a deep neural network (DNN) trained to estimate the target audio area based on the acoustic characteristics of the target speech and the playback audio signal. In one aspect, the DNN may be trained based on a default assumption that the device is in close proximity to the user (e.g., located on a coffee table relatively close to the user such as less than 1 meter away) and the TV is relatively far away (e.g., more than 2 meters away from the user). In one aspect, the target audio area may also be referred as a speech bubble surrounding the device.

The second stage may be a level-based suppressor that further attenuates the residual echo from the output of the first stage. The second stage may adaptively determine an audio level threshold to be compared with the output from the first stage. The level-based suppressor may act as an echo gate to suppress the output of the first stage when its audio signal level falls below the audio level threshold to further attenuate the residual echo of the playback audio. Otherwise, the level-based suppressor may preserve the output of the first stage when its audio signal level satisfies the audio level threshold to preserve the target audio signal. The second stage may have a noise tracker to track the noise floor.

In one aspect, the audio signal level of the first stage may be adjusted using automatic gain control (AGC) to equalize the estimated distance to the target audio source before the level-based suppressor operates on the output of the first stage. The AGC may effectively adapt the target audio area to bring the target audio source closer within the target audio area. The AGC in conjunction with the level-based suppressor may act as a level recovery mechanism to recover the target audio signal that may have been attenuated when the first stage attenuates the echo of the playback audio while further suppressing the residual echo of the playback audio or other interference signals.

In one aspect, the first stage may provide aiding information to the level recovery mechanism of the AGC and the level-based suppressor. For example, the first stage may determine a level of attenuation of the output audio signal from the first stage relative to the input audio signal to the first stage. The first stage may also determine whether the target audio signal is attenuated based on the level of attenuation calculated. The first stage may indicate to the AGC or the level-based suppressor an indication that the target audio signal has been attenuated. The AGC may increase the audio signal level of the output of the first stage when the target audio signal is indicated as being attenuated. Otherwise, the AGC may decrease the audio signal level of the output of the first stage. In one aspect, the AGC and the level-based suppressor may be modeled by digital signal processing (DSP) techniques. In one aspect, the AGC and the level-based suppressor may be modeled by a machine learning model.

In one aspect, the reference-less echo mitigation technique may adaptively adjust the target audio area of the first stage or the audio level threshold of the level-based suppressor of the second stage based on additional inputs. In one aspect, a processing module may estimate a distance of the target audio source, the TV, or other interference signal source based on audio and/or video signals to adjust the target audio area or the audio level threshold accordingly. In one aspect, a processing module may detect a face of a speaker of the target speech to adjust the target audio area or the audio level threshold according to whether the device is in a hand-held mode or in a coffee table mode. In one aspect, a processing module may estimate a loudness level of the target audio signal, the playback signal, or other interference signals to adjust the target audio area or the audio level threshold to strike a balance between suppressing the playback or the interference signals and preserving the target audio signal.

In one aspect, a processing module may estimate the acoustic characteristics of the environment of the device to adjust the target audio area or the audio level threshold. In one aspect, a processing module may distinguish between live speech and recorded speech based on reverberations of the audio signals or the spectral components of the audio signals even when the interference recorded speech from the audio playback originates from within the target audio area. The technique may use information provided by the one or more processing modules to generate an output signal that preserves as much as possible the target audio signal while suppressing the echo from the media playback or other interference signals before sending the output signal to the far-end listeners.

A method of suppressing audio interference signals is disclosed. The method includes a device capturing an input audio signal. The input audio signal may include a target signal and at least one interference signal. The method also includes using a machine learning model operating on the input audio signal to determine a target audio area relative to the device. The target audio area may distinguish between a source of the target signal estimated to be within the target audio area and a source of the interference signal estimated to be outside of the target audio area. The method further includes generating by the device based on the target audio area an output audio signal that preserves the target signal while suppressing the interference signal without the device having access to a reference copy of the interference signal.

The above summary does not include an exhaustive list of all aspects of the present disclosure. It is contemplated that the disclosure includes all systems and methods that can be practiced from all suitable combinations of the various aspects summarized above, as well as those disclosed in the Detailed Description below and particularly pointed out in the claims filed with the application. Such combinations have particular advantages not specifically recited in the above summary.

### BRIEF DESCRIPTION OF THE DRAWINGS

Several aspects of the disclosure here are illustrated by way of example and not by way of limitation in the figures of the accompanying drawings in which like references indicate similar elements. It should be noted that references to “an” or “one” aspect in this disclosure are not necessarily to the same aspect, and they mean at least one. Also, in the interest of conciseness and reducing the total number of figures, a given figure may be used to illustrate the features of more than one aspect of the disclosure, and not all elements in the figure may be required for a given aspect.

FIG. 1 depicts a scenario of a user speaking to an electronic device for the device to receive target speech of the user in an audio or video call according to one aspect of the disclosure.

FIG. 2 depicts a scenario of a user using an electronic device for a calling application in a shared playback mode in which the device streams media content to a television for local playback while transmitting the media content to far-end participants of the call for remote playback.

FIG. 3 depicts an electronic device modeling a target audio area around the device in which target speech estimated as originating from inside the target audio area is preserved and audio signals estimated as originating from outside the target audio area are suppressed according to one aspect of the disclosure.

FIG. 4 is a block diagram of a processing module for isolating target speech within a target audio area using a machine learning model and attenuating residual echo generated by the machine learning model using a level-based suppressor to suppress interference media echo in a mixed signal of target speech and media echo according to one aspect of the disclosure.

FIG. 5 is a block diagram of a processing module for using aiding or side information to adjust the target audio area and the level-based suppressor to suppress interference media echo in a mixed signal of target speech and media echo according to one aspect of the disclosure.

FIG. 6 is a flow diagram of a method for suppressing an interference signal from a target signal by isolating the target signal within a target audio area using a machine learning model and attenuating the interference signal based on the interference signal estimated as originating from outside the target audio area according to one aspect of the disclosure.

FIG. 7 is a flow diagram of a method for suppressing an interference signal from a target signal by isolating the target signal within a target audio area using a machine learning model and attenuating the interference signal based on the target audio area where side information is used to adjust the target audio area according to one aspect of the disclosure.

### DETAILED DESCRIPTION

When devices such as smartphones or intelligent personal assistant devices receive speech, voice commands, or user queries, collectively referred to as target speech, machine learning techniques implemented in a deep neural network (DNN) may be used to improve the intelligibility of the target speech in the presence of noise. The DNN may be trained to isolate the target speech and to remove noise and reverberation from the target speech to enhance the target speech for subsequent audio processing such as speech routing in telephony or video conferencing applications or speech recognition in voice command applications.

In one mode of the telephony or video conferencing applications, a device may transmit media content to far-end participants to allow a shared media playback experience among the participants. For example, a device of a local user may stream a movie to a television for local playback. The device may also transmit the movie to a device of a far-end user for remote playback on the far-end device or for the far-end device to stream the movie to a television of the far-end user. The local device may capture audio from the local playback as well as any target speech. To mitigate or cancel the echo of the local playback so as to prevent it from interfering with the remote playback, the DNN may be trained to isolate the target speech from the audio of the local playback before transmitting the isolated target speech to the far-end device. The echo of the local playback may be suppressed even without the availability of a reference version of the movie that would be conventionally employed for echo cancellation.

Systems and methods are disclosed for a reference-less echo mitigation or cancellation technique. The technique may be applied to mitigate echo of local playback of media content to prevent the echo from interfering with remote playback of the same media content in a shared media playback environment. The technique may be applied to more generally suppress interference signals from a target audio signal received by a device by distinguishing between estimated distances of the device from the source of the target audio and the source of the interference signals without relying on a reference copy of the interference signals.

In one aspect, the technique may involve a two-stage model. A first-stage DNN may estimate a target audio area surrounding the device based on the acoustic characteristics of the target audio and the interference signals. The target audio area may also be referred to as a speech bubble. The DNN may preserve the target signal such as target speech identified as originating from inside the target audio area and suppress interference signals such as media playback, interfering speech from a competing talker, or noise identified as originating from outside the target audio area. Using the target audio area, the DNN may suppress distant speech and keep near-field speech. In one aspect, the DNN may be trained to distinguish between live speech and recorded speech so that it may suppress recorded speech and keep live speech.

A second-stage AGC and level-based suppressor may be configured to gate residual interference signal such as residual echo of the media playback audio from the first-stage DNN based on an assumed level of the target audio. The AGC may adaptively increase the signal level of the output of the DNN to effectively bring the target audio source closer within the target audio area. The level-based suppressor may compare the enhanced audio from the AGC against an audio level threshold to suppress residual interference signals whose signal level falls below the audio level threshold. The second stage may act as a level recovery mechanism to recover the target signal that has been attenuated by the DNN while further suppressing the residual interference signals.

In one aspect, aiding or side information may be provided to the two stages to allow the DNN to adaptively adjust the target audio area, the AGC to adaptively adjust the gain, or the level-based suppressor to adaptively adjust the audio level threshold. The side information may include estimated distance to the target audio source or the interference signal source, face detection of a speaker of target speech to distinguish between the device being held by the target speaker or set down in proximity to the target speaker, estimates of room acoustics, estimates of speech level, estimates of live speech as distinguished from recorded speech, etc. The two-stage model may generate an echo-mitigated signal that preserves as much as possible the target signal while suppressing the interference signals before sending the echo-mitigated signal to far-end devices such as used by far-end participants in the telephony or video conferencing applications.

In the following description, numerous specific details are set forth. However, it is understood that aspects of the disclosure here may be practiced without these specific details. In other instances, well-known circuits, structures and techniques have not been shown in detail in order not to obscure the understanding of this description.

The terminology used herein is for the purpose of describing particular aspects only and is not intended to be limiting of the disclosure. Spatially relative terms, such as “beneath”, “below”, “lower”, “above”, “upper”, and the like may be used herein for ease of description to describe one element's or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (e.g., rotated 90 degrees or at other orientations) and the spatially relative descriptors used herein interpreted accordingly.

As used herein, the singular forms “a”, “an”, and “the” are intended to include the plural forms as well, unless the context indicates otherwise. It will be further understood that the terms “comprises” and “comprising” specify the presence of stated features, steps, operations, elements, or components, but do not preclude the presence or addition of one or more other features, steps, operations, elements, components, or groups thereof.

The terms “or” and “and/or” as used herein are to be interpreted as inclusive or meaning any one or any combination. Therefore, “A, B or C” or “A, B and/or C” mean any of the following: A; B; C; A and B; A and C; B and C; A, B and C.” An exception to this definition will occur only when a combination of elements, functions, steps or acts are in some way inherently mutually exclusive.

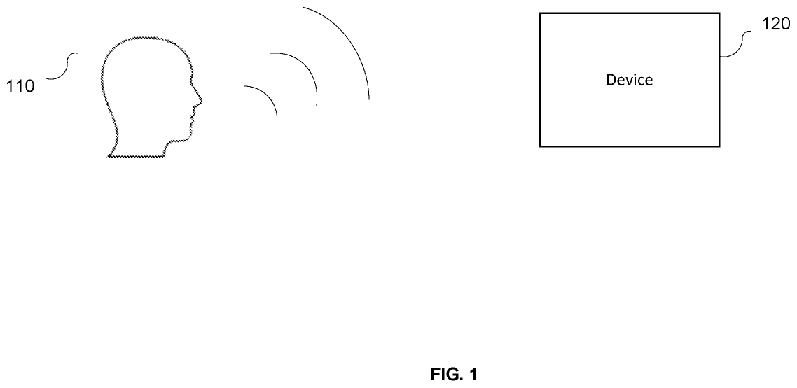

FIG. 1 depicts a scenario of a user 110 speaking to an electronic device 120 for the device to receive target speech of the user in an audio or video call according to one aspect of the disclosure. The electronic device 120 may be a smartphone, intelligent personal assistant device, smartwatch, tablet computer, etc. In other applications, the user 110 may issue a voice command to the electronic device 120. The electronic device 120 may include one or more microphones to capture target speech from the user 110. The target speech may be mixed with interference signals from the noisy environment. The electronic device 120 may divide the captured mixed signal into audio data frames and may transmit the audio data frames to other devices or a remote server.

In one aspect, a machine learning model running on the electronic device 120 or on a server may be trained to model characteristics of the mixed signal to filter or separate the target speech signal from interference signals to generate enhanced target speech signals. The enhanced target speech signals may be routed to far-end participants by the audio or video calling application to improve the intelligibility of the conversation or processed by automatic speech recognition applications to identify and interpret the voice command issued by the user 110.

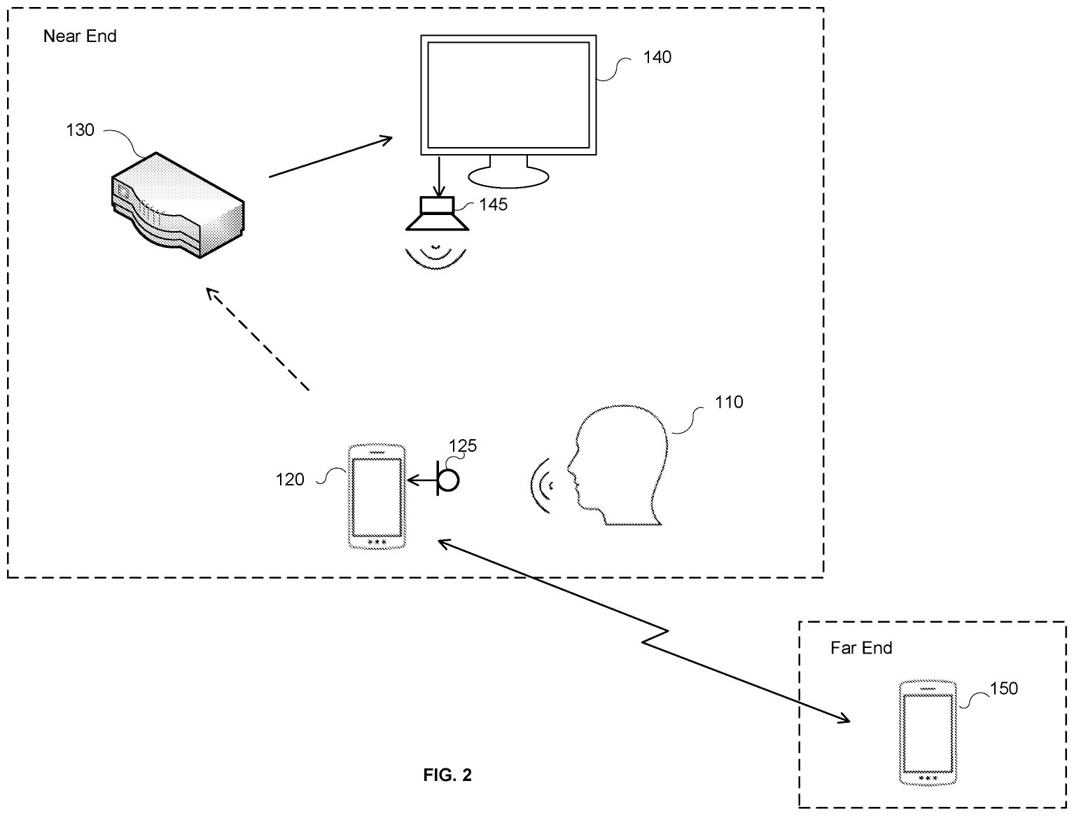

FIG. 2 depicts a scenario of a near-end user 110 using a calling application of a smartphone 120 in a shared playback mode in which the smartphone 120 streams media content to a television for local playback while transmitting the media content to one or more far-end participants of the call for remote playback. For example, while the near-end user 110 is conversing with a far-end user who is using a far-end smartphone 150, the near-end user 110 may want to share media content, such as a video clip, with a far-end user for the two users to partake in a shared media playback experience.

The smartphone 120 may transmit the media content to a media device 130 to render the audio and video content of the media. The media device 130 may transmit the audio and video content through a wired or a wireless connection to a television or a display monitor 140 for local playback. In one aspect, the smartphone 120 may transmit the media content directly to the monitor 140 for local playback. A speaker of the monitor 140 may project the audio signals of the media playback. One or more microphones 125 on the smartphone 120 may capture the audio playback signals as well as the target speech of the user 110.

The smartphone 120 may also transmit the media content to the far-end smartphone 150 through the calling application. The far-end smartphone 150 may transmit the received media content to a far-end display monitor for remote playback either directly or via a media device. If the audio signals from the local playback is not mitigated, the far-end user may hear not only the audio signals from the remote playback but also echoes from the local playback, detracting from the shared playback experience. Disclosed are techniques for echo suppression of the local playback audio without relying on a reference signal of the local playback audio.

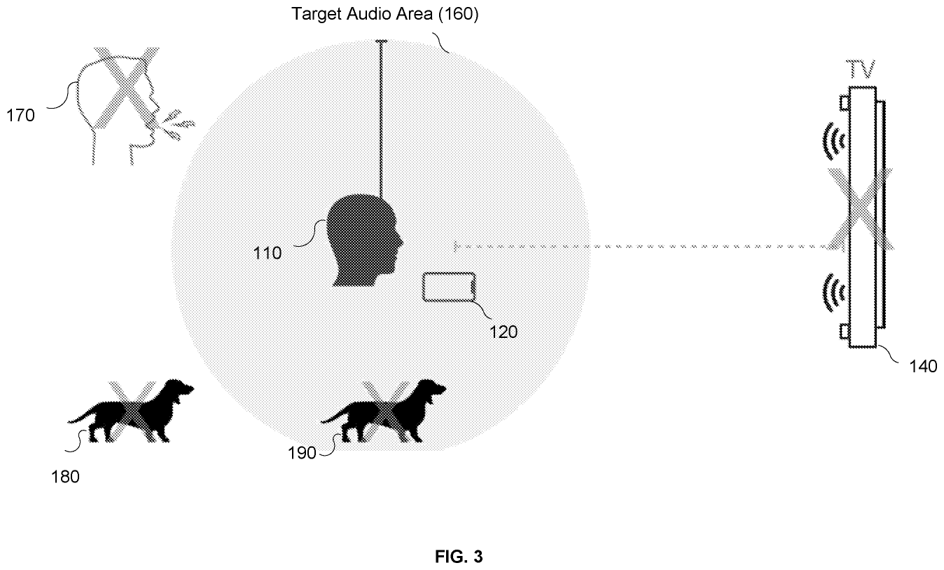

FIG. 3 depicts an electronic device 120 modeling a target audio area 160 (also referred to as a speech bubble) around the device 120 in which target speech estimated as originating from inside the target audio area 160 is preserved and audio signals estimated as originating from outside the target audio area 160 is suppressed according to one aspect of the disclosure.

The device 120 may estimate the target audio area 160 using a machine learning model such as the DNN. The DNN may be trained to distinguish between target speech and interference signals based on the acoustic characteristics of the target speech from the user 110 estimated as inside the target audio area 160 and acoustic characteristics of the interference signals estimated as originating from outside the target audio area 160. The interference signals may include speech from a competing speaker 170, audio playback from a television 140, or barking noise of a dog 180. The DNN may generate a filtered audio signal that suppresses the interference signals based on the inference that the interference signals originate from outside the target audio area 160.

In one aspect, the DNN may be trained to distinguish between live speech and recorded speech such as audio playback signals or other type of interference signals based on their acoustic characteristics even when the interference signals originate from inside the target audio area 160. For example, the DNN may infer non-speech signals such as the barking noise of a dog 190 that is inside the target audio area 160 so the DNN may suppress the barking noise. In one aspect, the DNN may operate in conjunction with a level-based suppressor to further attenuate any residual interference or echo in the filtered audio signal from the DNN.

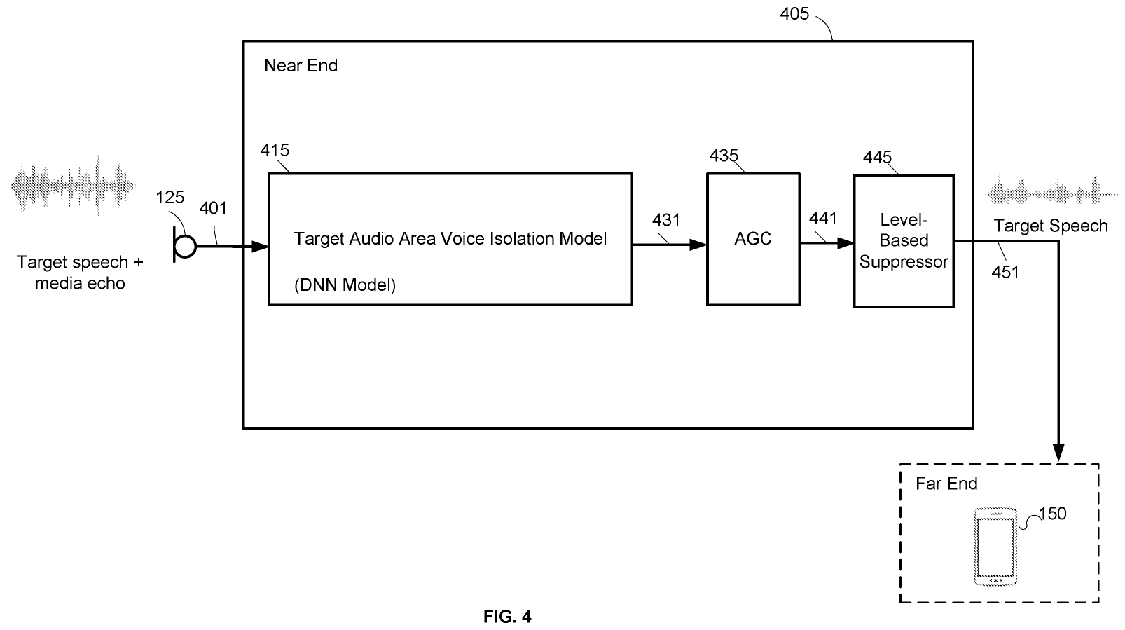

FIG. 4 is a block diagram of a processing module 405 for isolating target speech within a target audio area using a machine learning model and attenuating residual echo generated by the machine learning model using a level-based suppressor to suppress interference media echo in a mixed signal of target speech, media echo, and other interference signals according to one aspect of the disclosure. The processing module 405 may be implemented on the smartphone 120 running the shared playback mode of the calling application of FIG. 2 or on a remote server that receives the captured audio from the smartphone 120.

A target audio area voice isolation model 415 implemented by a DNN model may process the mixed signal 401 of target speech, media echo, and other interference signals captured by one or more microphones 125 of a device. The target audio area voice isolation model 415 may infer that the target speech component of the mixed signal 401 is uttered by a user within the target audio area and that the media echo component of the mixed signal 401 is played from a television outside of the target audio area.

In one aspect, the target audio area voice isolation model 415 may be trained to distinguish between near-field target speech and far-field playback audio based on a default assumption that the device is in close proximity to the user (e.g., located on a coffee table relatively close to the user such as less than 1 meter from the user) and the television is relatively far away (e.g., more than 2 meters away from the user). In one aspect, the target audio area voice isolation model 415 may be trained to distinguish between live speech and recorded speech from the playback audio even when the playback device is within the target audio area. For example, the target audio area voice isolation model 415 may distinguish between live speech and recorded speech based on acoustic characteristics such as reverberation, timbre, spectral changes, etc. In one aspect, the target audio area voice isolation model 415 may be trained to distinguish between near-field live speech uttered by a target talker and far-field live speech uttered by a competing talker outside of the target audio area. The target audio area voice isolation model 415 may attenuate the interference signal components such as the far-field media echo, the near-field recorded speech, the far-field live speech, etc., while preserving the target speech component of the mixed signal 401 to generate a filtered audio signal 431.

An automatic gain control (AGC) module 435 may adaptively change the signal level of the filtered audio signal 431 to recover target speech that may have been attenuated and to attenuate residual interference due to the filtering operations of the target audio area voice isolation model 415. The AGC module 435 may be used to equalize the distance to the speaker of the target speech by adapting the target audio area to effectively bring the speaker further into the target audio area.

In one aspect, the target audio area voice isolation model 415 may provide information to the AGC module 435 to aid in the target speech recovery and residual interference attenuation mechanism. For example, the target audio area voice isolation model 415 may determine a level of attenuation of the filtered audio signal 431 relative to the mixed signal 401. The target audio area voice isolation model 415 may indicate to the AGC module 435 whether the target speech has been attenuated based on the level of attenuation calculated. The AGC module 435 may increase the signal level of the filtered audio signal 435 when the target speech is indicated as being attenuated. Otherwise, the AGC module 435 may decrease the audio level of the filtered audio signal 435.

In one aspect, the target audio area voice isolation model 415 may estimate a voice activity detection (VAD) flag to indicate periods of active speech from non-speech segments of the target speech. In one aspect, the target audio area voice isolation model 415 may estimate the noise floor. The target audio area voice isolation model 415 may provide the VAD flag and the noise floor to the AGC module 435 for the AGC module 435 to increase the signal level of the filtered audio signal 435 when the VAD flag is asserted and to decrease the signal level of the filtered audio signal 435 otherwise.

The AGC module 435 may provide enhanced audio signal 441 to a level-based suppressor 445. The level-based suppressor 445 may be configured to gate residual interference signal such as residual echo of the media playback audio based on an assumed level of the target audio. For example, the level-based suppressor 445 may adaptively determine an audio level threshold to be compared with the enhanced audio signal 441 from the AGC module 435. The level-based suppressor 445 may act as an echo gate to suppress the enhanced audio signal 441 when its audio signal level falls below the audio level threshold to further attenuate the residual echo of the playback audio. Otherwise, the level-based suppressor 445 may preserve the enhanced audio signal 441 when its audio signal level satisfies the audio level threshold to preserve the target audio signal. In one aspect, the level-based suppressor 445 may have a noise tracker to track the noise floor.

The level-based suppressor 445 may also receive aiding information from the target audio area voice isolation model 415 such as an indication of whether the target speech has been attenuated, a VAD flag, noise floor, etc., discussed with respect to the AGC module 435. The level-based suppressor 445 may adjust the audio level threshold to recover attenuated target speech and to attenuate residual interference. In one aspect, the level-based suppressor 415 may reconstruct the target speech using cepstral envelope modeling. In one aspect, the AGC module 435 and the level-based suppressor 445 may be modeled by digital signal processing (DSP) techniques. In one aspect, the AGC 435 and the level-based suppressor 445 may be modeled by a machine learning model. The processing module 405 may transmit the echo-mitigated target speech signal 451 generated by the level-based suppressor 445 to a far-end smartphone through the calling application.

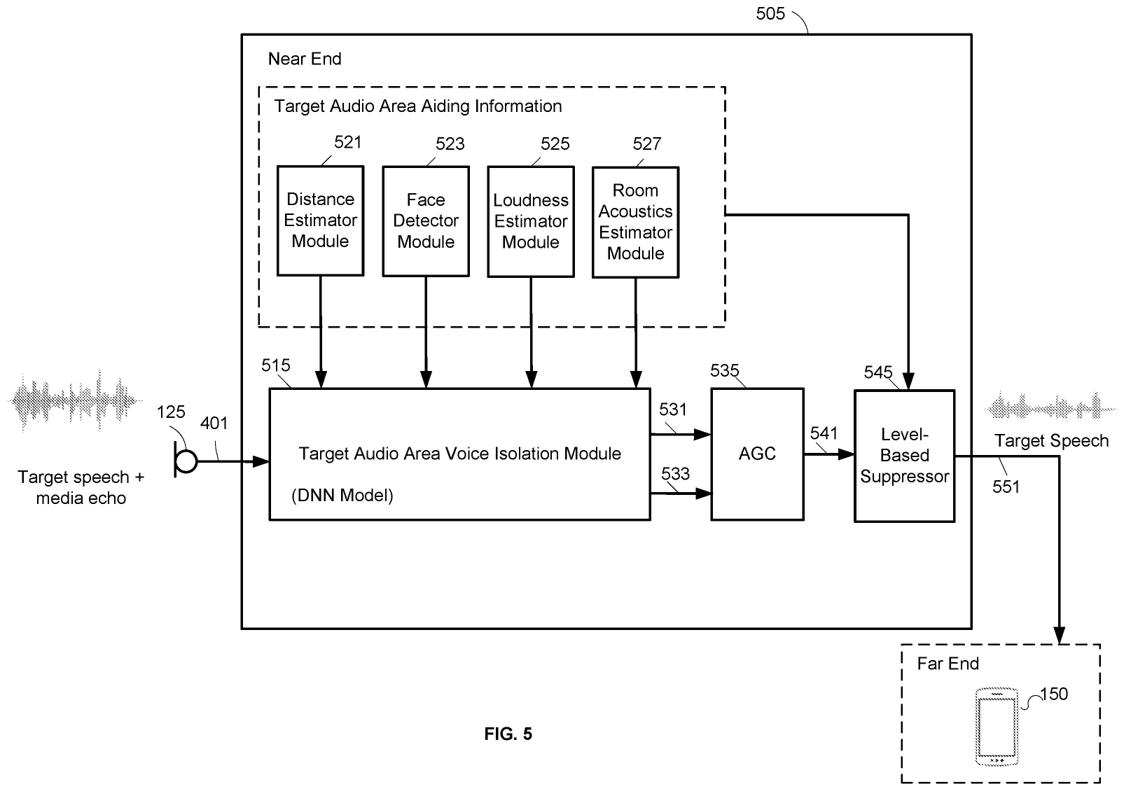

FIG. 5 is a block diagram of a processing module 505 for using aiding or side information to adjust the target audio area and the level-based suppressor to suppress interference media echo in a mixed signal of target speech and media echo according to one aspect of the disclosure. The processing module 505 may be implemented on the smartphone 120 running the shared playback mode of the calling application of FIG. 2 or on a remote server that receives the captured audio from the smartphone 120.

A target audio area voice isolation module 515 implemented by a DNN model may process the mixed signal 401 of target speech, media echo played by a television, and other interference signals to infer that the target speech is uttered by a user within an estimated target audio area and that the media echo and other interference signals originate from outside of the estimated target audio area, as in FIG. 4. The target audio area voice isolation module 515 may use side information to adjust the target audio area. For example, the DNN of the target audio area voice isolation module 515 may use the side information to pick different models or as an additional input that can be used implicitly. In one aspect, the side information may also be generated using a DNN model.

For example, a distance estimator module 521 may estimate a distance of the target audio source, the television, or other interference signal source from the smartphone 120 based on audio and/or video signals captured by the smartphone 120. The target audio area voice isolation module 515 may receive the estimated distances to the various signal sources to adaptively adjust the target audio area.

A face detector module 523 may process video signals or images captured by the smartphone 120 showing a face of a speaker of the target speech to detect whether the smartphone 120 is in the coffee table mode or the handheld mode. The target audio area voice isolation module 515 may receive information about the detected mode to adaptively adjust the target audio area.

A loudness estimator module 525 may process audio signals captured by the smartphone 120 to estimate a loudness level of the target audio signal, the media playback signal, or other interference signals. The target audio area voice isolation module 515 may receive the estimated loudness levels of the various signals to adaptively adjust the target audio area to strike a balance between suppressing the playback or the interference signals and preserving the target audio signal.

A room acoustics estimator module 527 may process reflected sound emitted by the smartphone 120 or video signals captured by a camera of the smartphone 120 to estimate the acoustic characteristics of the environment surrounding the smartphone 120. The target audio area voice isolation module 515 may receive the estimated room acoustics information to adaptively adjust the target audio area. In one aspect, the room acoustics estimator module 527 to distinguish between live speech and recorded speech based on reverberations or spectral components of the audio signals.

The target audio area voice isolation model 515 may attenuate the interference signal component while preserving the target speech component of the mixed signal 401 to generate a filtered audio signal 531 for the AGC module 535. The AGC module 535 may adaptively change the signal level of the filtered audio signal 531 to recover target speech that may have been attenuated and to attenuate residual interference, similar to the AGC module 435 of FIG. 4. The target audio area voice isolation model 515 may provide aiding information 533, such as an indication of whether the target speech has been attenuated, a VAD flag, noise floor, etc., to the AGC module 535. The AGC module 535 may use the aiding information 533 to generate enhanced audio signal 541 to the level-based suppressor 545, similar to the use of aiding information by the AGC module 435, as previously discussed.

The level-based suppressor 545 may gate residual interference in the enhanced audio signal 541 based on an audio level threshold. The level-based suppressor 545 may act as an echo gate to suppress the enhanced audio signal 541 when its audio signal level falls below the audio level threshold to further attenuate the residual echo of the playback audio. Otherwise, the level-based suppressor 545 may preserve the enhanced audio signal 541 when its audio signal level satisfies the audio level threshold to preserve the target audio signal. The level-based suppressor 545 may receive side information generated by one or more of the distance estimator module 521, face detector module 523, loudness estimator module 525, or room acoustic estimator module 527 to adjust the audio level threshold to recover attenuated target speech and to attenuate residual interference. The processing module 505 may transmit the echo-mitigated target speech signal 551 generated by the level-based suppressor 545 to a far-end smartphone through the calling application.

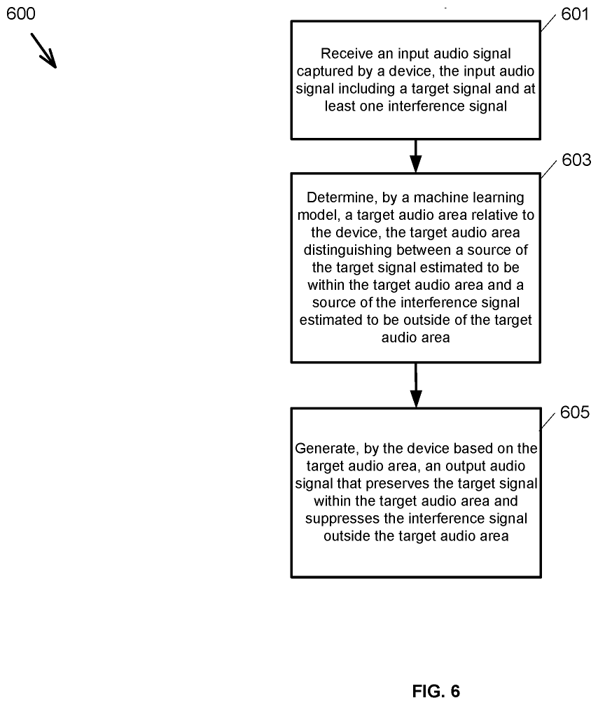

FIG. 6 is a flow diagram of a method 600 for suppressing an interference signal from a target signal by isolating the target signal within a target audio area using a machine learning model and attenuating the interference signal based on the interference signal estimated as originating from outside the target audio area according to one aspect of the disclosure. The method 600 may be practiced by the processing module 405 of FIG. 4.

In operation 601, the method 600 receives an input audio signal captured by a device. The input audio signal may include a target signal and at least one interference signal.

In operation 603, a machine learning model operates on the input audio signal to determine a target audio area relative to the device. The target audio area may distinguish between a source of the target signal estimated to be within the target audio area and a source of the interference signal estimated to be outside of the target audio area.

In operation 605, the method 600 generates, based on the target audio area, an output audio signal that preserves the target signal within the target audio area and suppresses the interference signal outside the target audio area.

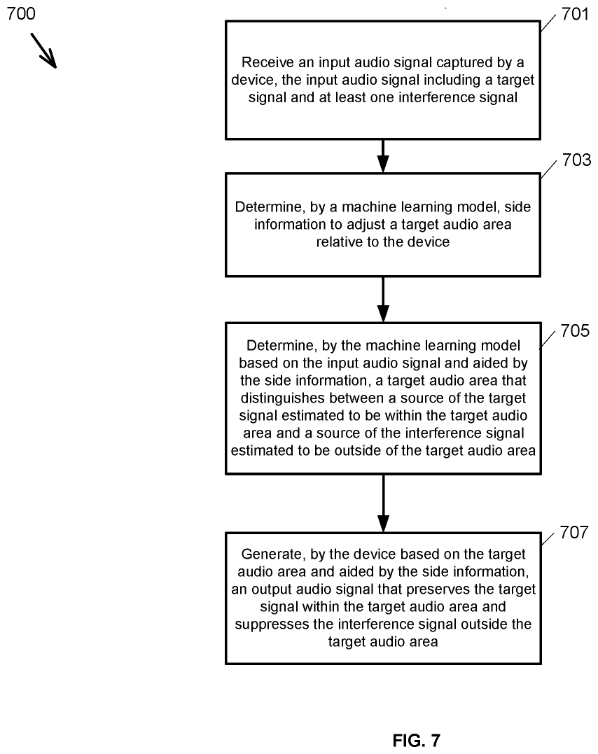

FIG. 7 is a flow diagram of a method 700 for suppressing an interference signal from a target signal by isolating the target signal within a target audio area using a machine learning model and attenuating the interference signal based on the target audio area where side information is used to adjust the target audio area according to one aspect of the disclosure. The method 600 may be practiced by the processing module 505 of FIG. 5.

In operation 701, the method 700 receives an input audio signal captured by a device. The input audio signal may include a target signal and at least one interference signal.

In operation 703, a machine learning model determines side information to adjust a target audio area relative to the device. The side information may include estimated distances to the target signal source and the interference signal source, information on whether the device is in the coffee table more or the handheld mode, estimated loudness levels of the target audio signal and the interference signal, estimated acoustic characteristics of the environment surrounding the device, etc.

In operation 705, the machine learning model operates on the input audio signal aided by the side information to determine the target audio area relative to the device. The target audio area may distinguish between a source of the target signal estimated to be within the target audio area and a source of the interference signal estimated to be outside of the target audio area.

In operation 707, the method 700 generates, based on the target audio area and aided by the side information, an output audio signal that preserves the target signal within the target audio area and suppresses the interference signal outside the target audio area.

Aspects of the deep learning system described herein may be implemented in a data processing system, for example, by a network computer, network server, tablet computer, smartphone, laptop computer, desktop computer, other consumer electronic devices or other data processing systems. In particular, the operations described for the deep learning system are digital signal processing operations performed by a processor that is executing instructions stored in one or more memories. The processor may read the stored instructions from the memories and execute the instructions to perform the operations described. These memories represent examples of machine readable non-transitory storage media that can store or contain computer program instructions which when executed cause a data processing system to perform the one or more methods described herein. The processor may be a processor in a local device such as a smartphone, a processor in a remote server, or a distributed processing system of multiple processors in the local device and remote server with their respective memories containing various parts of the instructions needed to perform the operations described.

The processes and blocks described herein are not limited to the specific examples described and are not limited to the specific orders used as examples herein. Rather, any of the processing blocks may be re-ordered, combined or removed, performed in parallel or in serial, as necessary, to achieve the results set forth above. The processing blocks associated with implementing the audio processing system may be performed by one or more programmable processors executing one or more computer programs stored on a non-transitory computer readable storage medium to perform the functions of the system. All or part of the audio processing system may be implemented as, special purpose logic circuitry (e.g., an FPGA (field-programmable gate array) and/or an ASIC (application-specific integrated circuit)). All or part of the audio system may be implemented using electronic hardware circuitry that include electronic devices such as, for example, at least one of a processor, a memory, a programmable logic device or a logic gate. Further, processes can be implemented in any combination hardware devices and software components.

While certain exemplary instances have been described and shown in the accompanying drawings, it is to be understood that these are merely illustrative of and not restrictive on the broad disclosure, and that this disclosure is not limited to the specific constructions and arrangements shown and described, since various other modifications may occur to those of ordinary skill in the art. The description is thus to be regarded as illustrative instead of limiting.

To aid the Patent Office and any readers of any patent issued on this application in interpreting the claims appended hereto, applicants wish to note that they do not intend any of the appended claims or claim elements to invoke 35 U.S.C. 112(f) unless the words “means for” or “step for” are explicitly used in the particular claim.

As described above, one aspect of the present technology is the transmission and use of speech or data from specific and legitimate sources to an audio output device. The present disclosure contemplates that in some instances, this speech or data may include personal information data such as speaker ID, speaker's harmonic structure, or speaker embedding that uniquely identifies or can be used to identify a specific person. Such personal information data can include demographic data, location-based data, online identifiers, telephone numbers, email addresses, home addresses, data or records relating to a user's health or level of fitness (e.g., vital signs measurements, medication information, exercise information), date of birth, or any other personal information. The present disclosure recognizes that the use of such personal information data, in the present technology, can be used to the benefit of users.

The present disclosure contemplates that those entities responsible for the collection, analysis, disclosure, transfer, storage, or other use of such personal information data will comply with well-established privacy policies and/or privacy practices. In particular, such entities would be expected to implement and consistently apply privacy practices that are generally recognized as meeting or exceeding industry or governmental requirements for maintaining the privacy of users. Such information regarding the use of personal data should be prominent and easily accessible by users, and should be updated as the collection and/or use of data changes. Personal information from users should be collected for legitimate uses only. Further, such collection/sharing should occur only after receiving the consent of the users or other legitimate basis specified in applicable law. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations that may serve to impose a higher standard. For instance, in the US, collection of or access to certain health data may be governed by federal and/or state laws, such as the Health Insurance Portability and Accountability Act (HIPAA); whereas health data in other countries may be subject to other regulations and policies and should be handled accordingly.

Despite the foregoing, the present disclosure also contemplates aspects in which users selectively block the use of, or access to, personal information data. That is, the present disclosure contemplates that hardware and/or software elements can be provided to prevent or block access to such personal information data.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing identifiers, controlling the amount or specificity of data stored (e.g., collecting location data at city level rather than at an address level), controlling how data is stored (e.g., aggregating data across users), and/or other methods such as differential privacy.

Therefore, although the present disclosure broadly covers the transmission of use of personal information data to implement one or more various disclosed aspects, the present disclosure also contemplates that the various aspects can also be implemented without the need for accessing such personal information data. That is, the various aspects of the present technology are not rendered inoperable due to the lack of all or a portion of such personal information data. For example, content can be selected and delivered to users based on aggregated non-personal information data or a bare minimum amount of personal information, such as the content being handled only on the user's device or other non-personal information available to the content delivery services.

What is claimed is:

1. A method of suppressing audio interference signals, the method comprising:
receiving an input audio signal captured by a device, the input audio signal including a target signal and at least one interference signal;
determining, by a machine learning model based on the input audio signal, a target audio area relative to the device, the target audio area distinguishing between a source of the target signal estimated to be within the target audio area and a source of the interference signal estimated to be outside of the target audio area; and
generating, by the device based on the target audio area, an output audio signal that preserves the target signal within the target audio area and suppresses the interference signal outside the target audio area.

2. The method of claim 1, wherein the target audio area identifies a distance boundary of an audio source from the device, and wherein the source of the target signal is determined as closer to the device than the distance boundary and the source of the interference signal is determined as farther away from the device than the distance boundary.

3. The method of claim 1, wherein determining by the machine learning model the target audio area comprises:
receiving by the machine learning model an estimated distance of the source of the target signal or the source of the interference signal from the device to adjust the target audio area;
receiving by the machine learning model a detected face of a speaker of the target signal to adjust the target audio area when the target signal includes speech from the speaker;
receiving by the machine learning model an estimated audio level of the target signal or the interference signal to adjust the target audio area; or
receiving by the machine learning model estimated acoustic characteristics of an environment of the device to adjust the target audio area.

4. The method of claim 1, further comprising:
determining, by the machine learning model, that the target signal comprises live speech and the interference signal comprises recorded speech.

5. The method of claim 1, further comprising:
determining, by the machine learning model, that the interference signal comprises non-speech originating from within the target audio area; and
generating the output audio signal that preserves the target signal while suppressing the interference signal without having access to a reference copy of the interference signal.

6. The method of claim 1, wherein generating the output audio signal further comprises:
generating, by the machine learning model, a filtered audio signal that attenuates the interference signal based on the source of the interference signal estimated to be outside of the target audio area to reduce interference on the target signal;
adjusting a gain of the filtered audio signal to generate a gain-adjusted output audio signal;
determining an audio level threshold;
suppressing the gain-adjusted output audio signal when an audio level of the gain-adjusted output audio signal falls below the audio level threshold; and
preserving the gain-adjusted output audio signal when the audio level of the gain-adjusted output audio signal satisfies the audio level threshold.

7. The method of claim 6, wherein adjusting the gain of the filtered audio signal comprises:
determining, by the machine learning model, an indication of a level of attenuation of the filtered audio signal relative to the input audio signal;
determining whether the target signal is also attenuated based on the indication;
increasing the gain of the filtered audio signal to recover the target signal in response to the target signal is determined as being attenuated; and
decreasing the gain of the filtered audio signal to further attenuate the interference signal in responsive to the target signal is determined as not being attenuated.

8. The method of claim 6, wherein determining the audio level threshold comprises:
estimating a distance of the source of the target signal or the source of the interference signal from the device to adjust the audio level threshold;
detecting a face of a speaker of the target signal to adjust the audio level threshold when the target signal includes speech;
estimating an audio level of the target signal or the interference signal to adjust the audio level threshold; or
estimating acoustic characteristics of an environment of the device to adjust the audio level threshold.

9. The method of claim 1, further comprising:
training the machine learning model to learn acoustic characteristics of the target signal that originates from within the target audio area and acoustic characteristics of the interference signal that originates from outside of the target audio area.

10. The method of claim 1, further comprising:
transmitting, by the device to a remote device, media content for the remote device to playback the media content; and
transmitting, by the device to the remote device, the output audio signal, wherein the target signal comprises speech of a user of the device, wherein the interference signal comprises a local playback of the media content in a local environment of the device, and wherein the output audio signal suppresses an echo of the local playback of the media content received by the device.

11. A device comprising:
a processor; and
a memory coupled to the processor to store instructions, which when executed by the processor, cause the processor to:
determine, by a machine learning model, a target audio area relative to the device based on an audio input signal including a target signal and at least one interference signal received by the device, wherein the target audio area distinguishes between a source of the target signal estimated to be within the target audio area and a source of the interference signal estimated to be outside of the target audio area; and
generate, based on the target audio area, an output audio signal that preserves the target signal within the target audio area and suppresses the interference signal outside the target audio area.

12. The device of claim 11, wherein the target audio area identifies a distance boundary of an audio source from the device, and wherein the source of the target signal is determined as closer to the device than the distance boundary and the source of the interference signal is determined as farther away from the device than the distance boundary.

13. The device of claim 11, wherein to determine the target audio area, the processor further executes the instructions to cause the machine learning model to:
receive an estimated distance of the source of the target signal or the source of the interference signal from the device to adjust the target audio area;
receive a detected face of a speaker of the target signal to adjust the target audio area when the target signal includes speech from the speaker;
receive an estimated audio level of the target signal or the interference signal to adjust the target audio area; or
receive estimated acoustic characteristics of an environment of the device to adjust the target audio area.

14. The device of claim 11, wherein the processor further executes the instructions to cause the machine learning model to:
determine that the target signal comprises live speech and the interference signal comprises recorded speech.

15. The device of claim 11, wherein the processor further executes the instructions to cause the machine learning model to:
determine that the source of the interference signal comprises non-speech originating from within the target audio area; and
generate the output audio signal that preserves the target signal and suppresses the interference signal without access to a reference copy of the interference signal.

16. The device of claim 11, wherein to generate the output audio signal, the processor further executes the instructions to:
determine, by the machine learning model, a filtered audio signal that attenuates the interference signal based on the source of the interference signal determined as located outside of the target audio area to reduce interference on the target signal;
adjust a gain of the filtered audio signal to generate a gain-adjusted output audio signal;
determine an audio level threshold;
suppress the gain-adjusted output audio signal when an audio level of the gain-adjusted output audio signal falls below the audio level threshold; and
preserve the gain-adjusted output audio signal when an audio level of the gain-adjusted output audio signal satisfies the audio level threshold.

17. The device of claim 16, wherein to adjust the gain of the filtered audio signal, the processor further executes the instructions to:
determine, by the machine learning model, an indication of a level of attenuation of the filtered audio signal relative to the input audio signal;
determine whether the target signal is also attenuated based on the indication;
increase the gain of the filtered audio signal to recover the target signal in response to the target signal is determined as being attenuated; and
decrease the gain of the filtered audio signal to further attenuate the interference signal in responsive to the target signal is determined as not being attenuated.

18. The device of claim 16, wherein to determine the audio level threshold, the processor further executes the instructions to:
estimate a distance of the source of the target signal or the source of the interference signal from the device to adjust the audio level threshold;
detect a face of a speaker of the target signal to adjust the audio level threshold when the target signal includes speech;
estimate an audio level of the target signal or the interference signal to adjust the audio level threshold; or
estimate acoustic characteristics of an environment of the device to adjust the audio level threshold.

19. The device of claim 11, wherein the processor further executes the instructions to:
transmit by the device to a remote device media content for the remote device to playback the media content; and
transmit by the device to the remote device the output audio signal, wherein the target signal comprises speech of a user of the device, wherein the interference signal comprises a local playback of the media content in a local environment of the device, and wherein the output audio signal suppresses an echo of the local playback of the media content received by the device.

20. A non-transitory computer-readable medium having instructions stored therein, which when executed by a processor, cause the processor to perform operations comprising:
determine, by a machine learning model, a target audio area relative to a device based on an audio input signal including a target signal and at least one interference signal received by the device, wherein the target audio area distinguishes between a source of the target signal estimated to be within the target audio area and a source of the interference signal estimated to be outside of the target audio area; and
generate, based on the target audio area, an output audio signal that preserves the target signal within the target audio area and suppresses the interference signal outside the target audio area.
